(19) United States
(12) Patent Application Publication
(10) Pub. No.: US 2024/0409361 A1
(43) Pub. Date: Dec. 12, 2024

(54) ELEVATOR SYSTEM WITH INCREASED LANDING ACCURACY

(71) Applicant: Inventio AG, Hergiswil (CH)

(72) Inventor: Claudio Colombano, Beckenried (CH)

(21) Appl. No.: 18/700,750

(22) PCT Filed: Oct. 8, 2022
(86) PCT No.: PCT/EP2022/077998

§ 371 Date: Apr. 12, 2024

(30) Foreign Application Priority Data
Oct. 19, 2021 (EP) 21203311.2

(51) Int. Cl. B66B 1/34; B66B 1/36

(52) U.S. Cl. CPC B66B 1/3492; B66B 1/3407; B66B 1/36; B66B 2201/30

(57) ABSTRACT

An elevator system is provided in which an elevator car is movable in an elevator shaft between two adjacent floors of a building using a traction sheave drive, wherein an elevator control unit for moving the elevator car from one of the floors to the other of the floors controls the traction sheave drive by means of a control signal using a value for the traction sheave diameter, the elevator controller being further designed to control after an initial configuration of the elevator system with an iterative adaptation of the value for the traction sheave diameter used to determine the control signal in order to increase the landing accuracy of the elevator car.

### FIELD

The invention relates to an elevator system with increased landing accuracy.

### BACKGROUND

Elevator systems used to transport people from one floor of a building to another floor of the building are already known. These elevator systems have a car positioned in an elevator shaft and attached to at least one suspension rope, the suspension rope being driven by a drive unit and being connected, for example via an idler pulley, to a counterweight provided at the other end of the suspension rope.

The drive unit has as drive, for example, an electric motor which is provided for driving a traction sheave. This traction sheave is provided on its outer circumference with teeth which engage in counterteeth provided on the suspension rope for transporting the suspension rope.

A movement of the elevator car from one floor to another floor of the building is controlled by an elevator control unit located in a machine room. This machine room may also contain the drive unit and the idler pulley for the suspension rope.

The elevator control unit is connected to a device for determining the car position, which provides the elevator control unit with data containing information about the current car position. The elevator control unit receives this data, evaluates it and provides control commands for elevator operation, in particular a control signal for the drive unit of the elevator system.

The elevator control unit is a computer unit equipped with a memory, in which a working program is stored which has been created in advance on the basis of predefined characteristic data of the elevator system and with the aid of which the elevator control unit determines the control signals required during operation. These characteristic data include, among other things, information on the length and material properties of the suspension rope, the height and weight of the elevator car and the traction sheave diameter. Furthermore, the specified characteristics include information about the travel speed of the elevator car and the time required for the elevator car to move from one floor to another.

If the building in which the elevator system is installed has more than two floors, then the device for determining the car position has a so-called absolute positioning system, for the realization of which a code mark pattern and a sensor device are necessary. This code mark pattern is placed along the entire travel distance of the elevator car in the elevator shaft and consists of a plurality of code marks. These code marks each contain a numerical coding of an absolute position of the elevator car in the elevator shaft relative to a reference point. The sensor device is attached to the elevator car and scans the code marks without contact while the elevator car is moving in order to provide the elevator control unit with information about the current absolute position of the elevator car.

However, the installation of such an absolute positioning system is associated with a high amount of work and thus with comparatively high installation costs.

### SUMMARY

An object of the invention is to show a simple and inexpensive way of improving the landing accuracy of the elevator car at a target floor for simple elevator systems whose car has to be moved between only two floors.

This object is solved by an elevator system having the features indicated in advantageous embodiments and further developments of the invention explained in the following description.

According to the present invention, an elevator system is provided in which an elevator car is movable in an elevator shaft between two adjacent floors of a building using a traction sheave drive, wherein an elevator control unit for moving the elevator car from one of the floors to the other of the floors controls the traction sheave drive by means of a control signal determined using a memorized value for the traction sheave diameter, the elevator control unit being further designed to control after an initial configuration of the elevator system with an iterative adaptation of the value for the traction sheave diameter used to determine the control signal in order to increase the landing accuracy of the elevator car.

The advantages of the invention consist in particular in the fact that no installation- and cost-intensive absolute positioning system is required to ensure that the elevator car lands at a predefined landing area during normal working operation of the elevator system, i.e. during a transport of persons from one floor of the building to the respectively adjacent floor of the building, and does not stop already before or afterwards. In particular, no code mark pattern consisting of a plurality of code marks applied along the entire travel path of the elevator car is required for the realization of the invention, the code marks each containing a numerical coding of an absolute position of the elevator car in the elevator shaft with respect to a reference point. To implement the invention, only two position flags of predetermined length are required, one of which is assigned to a first floor of the building and the second to the second floor of the building. Neither of these position flags needs a numerical coding of an absolute position of the elevator car.

Further advantageous features of the invention can be seen from the following exemplary explanation thereof with reference to the drawings.

### DESCRIPTION OF THE DRAWINGS

FIG. 1 shows a schematic diagram of an elevator system having an elevator car movable between the two floors of a two-floor building.

FIG. 2 shows a flow chart illustrating a method for increasing the landing accuracy of the elevator car.

### DETAILED DESCRIPTION

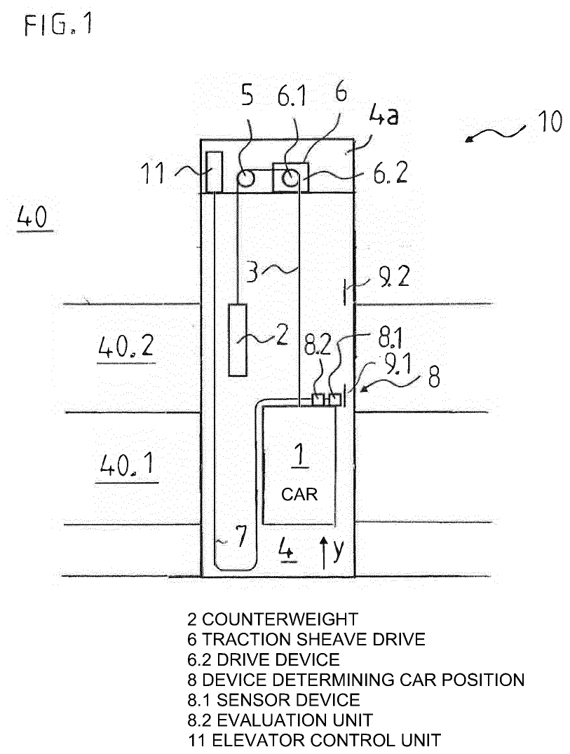

FIG. 1 shows a schematic diagram of an elevator system 10 having an elevator car 1 movable between the two floors 40.1 and 40.2 of a two-floor building 40.

In this elevator system 10, the elevator car 1 and a counterweight 2 are suspended from opposite ends of a suspension rope 3 in an elevator shaft 4 of the building 40. The suspension rope 3 passes over an idler pulley 5 and is driven by a drive device 6.2 via a traction sheave 6.1. The traction sheave 6.1 and the drive device 6.2 form a traction sheave drive 6. In the embodiment shown in FIG. 1, this traction sheave drive 6 is positioned in a separate machine room 4a together with the idler pulley 5 and an elevator control unit 11. This machine room 4a is arranged above the elevator shaft 4 in the embodiment example shown. However, the traction sheave drive 6, the idler pulley 5 and the elevator control unit 11 can also be located directly in the elevator shaft 4.

By turning the traction sheave 6.1 to the left or to the right, the elevator car 1 is moved along a travel path in or against a direction y and serves the two floors 40.1 and 40.2 of the building 40.

A device 8 is provided for determining the car position, which includes a sensor device 8.1 and an evaluation unit 8.2. This sensor device 8.1 and the evaluation unit 8.2 are attached to the elevator car 1 and are moved together with the elevator car 1. During this movement of the elevator car 1, the sensor device 8.1 detects position flags 9.1 and 9.2 attached in the elevator shaft 4, with the position flag 9.1 being assigned to floor 40.1 and the position flag 9.2 being assigned to floor 40.2.

In the example shown in FIG. 1, the sensor device 8.1 and the evaluation unit 8.2 are mounted on the top of the elevator car 1. The position flags 9.1 and 9.2 each have a predetermined length in the y direction of travel, which is 20 cm, for example. The central areas of the position flags 9.1 and 9.2 in the direction of travel are attached in the elevator shaft 4 at height positions at which the sensor device 8.1 is located when the elevator car 1 has arrived within a predetermined landing area of the respective target floor. If the elevator car 1 does not land exactly in this predetermined landing area after its travel, but higher or lower than it, then the sensor device 8.1 is located, for example, in the upper or lower edge area of the respective position flag, which can be detected by the evaluation unit 8.2 or the elevator control unit 11. The evaluation unit 8.2 translates the sensor signals provided by the sensor device 8.1 into a data format suitable for the elevator control unit 11 and forwards this data to the elevator control unit 11 via a suspension cable 7. The elevator control unit 11 uses this data to provide control commands according to a predefined working program which are necessary for the travel operation of the elevator car, for example control commands for the traction sheave drive of the elevator system.

During installation of the elevator system shown in FIG. 1, the memory associated with elevator control unit 11 is filled with data required by the elevator control unit during operation of the elevator system. These data include a working program and characteristic data describing individual properties of the individual components of the elevator system. These characteristic data include inter alia information on the length and material properties of the suspension rope 3, the height and weight of the elevator car 1 and on the traction sheave diameter. Furthermore, the specified characteristic data include information about the travel speed of the elevator car and the time required by the elevator car to transport from one floor to the other floor.

During operation of the elevator system, the elevator control unit uses the data stored in the memory, among other things, to provide the traction sheave drive 6 with control signals that cause the traction sheave 6.1 to rotate in the desired direction in such a way that the elevator car 1 is moved from one floor to the other. In practice, using the data stored in the memory, a required landing accuracy of the elevator car in a predetermined landing area of the target floor often cannot be achieved due to manufacturing inaccuracies of the components of the elevator system and inaccuracies in the assembly of these components. Therefore, in order to achieve the necessary landing accuracy, additional measures are taken to improve the landing accuracy based on the data originally stored in the memory to such an extent that the desired landing accuracy in a predetermined landing area is ensured.

In accordance with the present invention, this is achieved by the elevator control unit 11 being designed to control, after an initial configuration of the elevator system 10 has been performed, with an iterative adaptation of the value for the traction sheave diameter used to determine the control signal using the data stored in the memory to increase the landing accuracy of the elevator car 1.

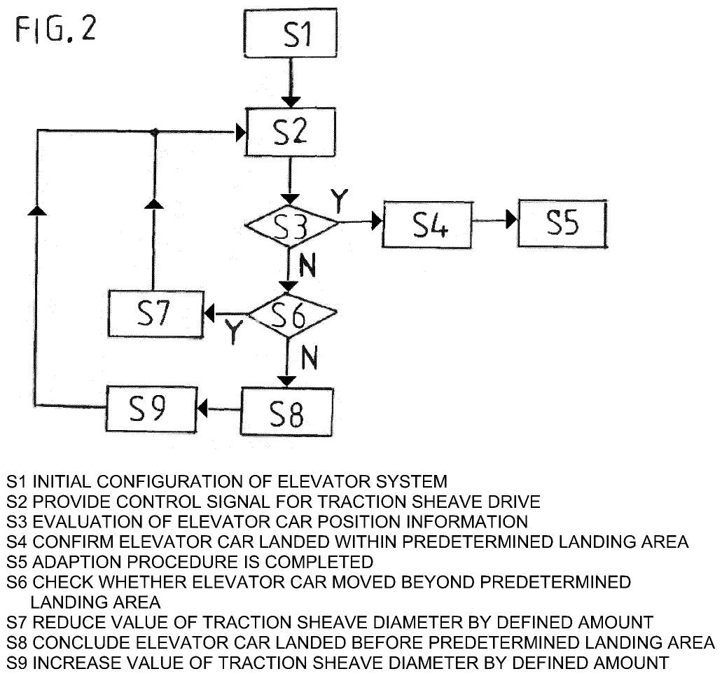

This is explained below with reference to FIG. 2, which shows a flow chart illustrating a method for increasing the landing accuracy of the elevator car.

In a step S1, the aforementioned initial configuration of the elevator system takes place, in which the above-mentioned data are stored in the memory of the elevator control unit 11.

This data, which include, among other things, a predetermined value for the traction sheave diameter of the traction sheave 6.1, is used by the elevator control unit 11 in a subsequent step S2 to provide a control signal for the traction sheave drive 6, which causes the traction sheave 6.1 to rotate in such a way that the elevator car is moved from one floor to the adjacent floor.

Then, in a step S3, an evaluation of the information about the position of the elevator car provided by the device 8 for determining the car position is used to check whether or not the elevator car has landed within the predetermined landing area of the target floor.

If the elevator car has landed within the predetermined landing area of the target floor, then the system proceeds to a step S4.

In step S4 it is confirmed that the elevator car has landed within the predetermined landing area and that an adaptation of the value for the traction sheave diameter is not necessary.

From step S4, there is a transition to step S5, with which the adaptation procedure is completed.

If, on the other hand, it is determined in step S3 that the elevator car has not landed within the predetermined landing area, then a transition is made to step S6.

In step S6, a check is performed to determine whether or not the elevator car has moved beyond the predetermined landing area.

If it is detected in step S6 that the elevator car has moved beyond the predetermined landing area, then a transition is made to step S7. In step S7, the value specified for the traction sheave diameter is reduced by a defined amount. This defined amount depends on the length of the position flags and corresponds, for example, to half the length of the position flags. This changed value for the traction sheave diameter is stored in the memory to replace the originally stored value for the traction sheave diameter.

From step S7, there is a return to step S2, in which the elevator control unit 11 now provides a modified control signal for the traction sheave drive 6, the reduced value for the traction sheave diameter being used to determine this modified control signal. By means of this modified control signal, the elevator car is again moved between the two floors of the building.

After this, the next step is step S3, in which the information about the position of the elevator car provided by the device 8 for determining the car position is evaluated to determine whether or not the elevator car has landed within the predetermined landing area of the target floor.

If the elevator car has landed within the predetermined landing area of the target floor, then the system proceeds to step S4.

In step S4, it is confirmed that the elevator car has landed within the predetermined landing area and that further adaptation of the traction sheave diameter value is not necessary.

Step S4 is followed by step S5, which concludes the adaptation procedure.

If, on the other hand, it is determined in step S3 that the elevator car has not landed within the predetermined landing area even when the reduced value for the traction sheave diameter is applied, then there is again a transition to step S6.

In step S6, a check is made to determine whether or not the elevator car has moved beyond the predetermined landing area.

If it is detected in step S6 that the elevator car has moved beyond the predetermined landing area, then there is again a transition to step S7. In step S7, a further reduction of the value specified for the traction sheave diameter by a defined amount takes place. This defined amount is again dependent on the length of the position flags and corresponds, for example, to a quarter of the length of the position flags. This changed value for the traction sheave diameter is stored in the memory to replace the previously stored value for the traction sheave diameter.

From step S7, there is a return back to step S2, in which the elevator control unit 11 provides another modified control signal for the traction sheave drive 6, wherein the again reduced value for the traction sheave diameter is used to determine this again modified control signal. The elevator car is moved again between the two floors of the building by means of this again modified control signal.

The next step is step S3, in which the information about the position of the elevator car provided by the device 8 for determining the car position is again evaluated to determine whether or not the elevator car has landed within the predetermined landing area of the target floor.

If the elevator car has landed within the predetermined landing area of the target floor, then the system proceeds to step S4.

In step S4, the elevator control unit receives confirmation that the elevator car has landed within the predetermined landing area and that no further adaptation of the traction sheave diameter value is necessary.

From step S4, there is a transition to step S5, with which the adaptation procedure is completed.

If, on the other hand, it is detected in step S6 that the elevator car has not moved beyond the predetermined landing area, then it is concluded in step S8 that the elevator car has already landed before the predetermined landing area, i.e. has not reached the predetermined landing area.

From step S8 there is a transition to a step S9. In step S9, the value specified for the traction sheave diameter is increased by a defined amount. This defined amount depends on the length of the position flags and corresponds, for example, to half the length of the position flags. This changed value for the traction sheave diameter is stored in the memory to replace the stored value for the traction sheave diameter.

From step S9, there is a return back to step S2, in which a modified control signal for the traction sheave drive 6 is now provided by the elevator control unit 11, the stored value for the traction sheave diameter being used to determine this modified control signal. By means of this modified control signal, the elevator car is again moved between the two floors of the building.

After this, a transition is made to step S3, in which an evaluation of the information about the position of the elevator car provided by the device 8 for determining the car position is used to check whether or not the elevator car has landed within the predetermined landing area of the target floor.

If the elevator car has landed within the predetermined landing area of the target floor, then the system proceeds to step S4.

In step S4, it is confirmed that the elevator car has landed within the predetermined landing area and that further adaptation of the traction sheave diameter value is not necessary.

Step S4 is followed by step S5, which concludes the adaptation procedure.

In the manner described above and illustrated in FIG. 2, the value for the traction sheave diameter used to determine the control signal for the traction sheave drive is adapted iteratively until the elevator car has achieved the desired landing accuracy on the basis of the control signal used. The value for the traction sheave diameter after completion of the adaptation is and remains stored in the memory and is used by the elevator control unit to control the elevator operation together with other stored data and other sensor signals provided during normal operation of the elevator system.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. An elevator system in which an elevator car is moved in an elevator shaft between two adjacent floors of a building using a traction sheave drive, the elevator system comprising:
an elevator control unit for moving the elevator car from one of the floors to the other of the floors by controlling the traction sheave drive with a control signal determined using a value for a diameter of a traction sheave of the traction sheave drive;
a device determining a position of the elevator car, the device including a sensor device that detects during travel of the elevator car position flags fastened in the elevator shaft;
wherein the elevator control unit controls the traction sheave drive after an initial configuration of the elevator system with an iterative adaptation of the value for the traction sheave diameter used to determine the control signal to increase a landing accuracy of the elevator car;
wherein the position flags each have a predetermined length in a direction of travel of the elevator car; and
wherein a defined amount by which the elevator control unit changes the value of the traction sheave diameter during the iterative adaptation is dependent on the predetermined length of the position flags.

13. The elevator system according to claim 12 wherein the elevator control unit uses the changed value for the traction sheave diameter for determining the control signal for the traction sheave drive during the iterative adaptation of the traction sheave diameter.

14. The elevator system according to claim 12 wherein the elevator control unit terminates the iterative adaptation when the landing accuracy of the elevator car is within a predetermined landing area.

15. The elevator system according to claim 14 wherein the elevator control unit reduces the value of the traction sheave diameter by a defined amount when the elevator car moves beyond the predetermined landing area.

16. The elevator system according to claim 14 wherein the elevator control unit increases the value of the traction sheave diameter by a defined amount when the predetermined landing area is not reached by the elevator car.

17. The elevator system according to claim 12 wherein the device determining the elevator car position includes an evaluation unit connected to the sensor device, and wherein the evaluation unit converts sensor signals provided by the sensor device into position information.

18. The elevator system according to claim 17 wherein the evaluation unit is connected to the elevator control unit and forwards the position information to the elevator control unit.

19. The elevator system according to claim 17 wherein one of the position flags is assigned to one of the floors and another of the position flags is assigned to another of the floors.

20. The elevator system according to claim 12 wherein the predetermined length of the position flags is 20 cm.

21. The elevator system according to claim 12 wherein after the initial configuration of the elevator system the elevator car is moved from one of the floors to another of the floors and the device determines the elevator car position for use in the iterative adaption.

22. The elevator system according to claim 12 wherein the defined amount by which the elevator control unit changes the value of the traction sheave diameter during the iterative adaptation is halved between iterations.
